(19) United States
(12) Patent Application Publication
(10) Pub. No.: US 2020/0384724 A1
(43) Pub. Date: Dec. 10, 2020

(54) Carbon Fiber Reinforced Plastic Plate and Method for Producing Carbon Fiber Reinforced Plastic Plate

(71) Applicant: Futaba Corporation, Mobara-shi (JP)

(72) Inventors: Yusuke Hoshina, Mobara-shi (JP); Satoshi Nagai, Mobara-shi (JP)

(21) Appl. No.: 16/894,166

(22) Filed: Jun. 5, 2020

(30) Foreign Application Priority Data
Jun. 6, 2019 (JP) 2019-106345

(51) Int. Cl. B32B 5/02; B32B 38/00; B32B 27/38; B32B 5/26; B29C 70/12; B29C 70/22; B29C 71/02; B29C 70/54

(52) U.S. Cl. CPC B32B 5/024; B32B 5/022; B32B 38/0036; B32B 27/38; B32B 5/26; B29C 70/12; B29K 2307/04; B29C 71/02; B29C 70/545; B32B 2250/40; B32B 2038/0076; B32B 2262/106; B32B 2250/20; B29C 70/22

(57) ABSTRACT

A carbon fiber reinforced plastic plate and a method of producing a carbon fiber reinforced plastic plate which can satisfy processability, smoothness after processing and strength are provided. A carbon fiber reinforced plastic plate includes: a first carbon fiber reinforced plastic layer including a carbon fiber woven fabric and a base material; and a second carbon fiber reinforced plastic layer including a carbon fiber nonwoven fabric and a base material and having a thickness of 3 mm or less, wherein the second carbon fiber reinforced plastic layer is laminated on the first carbon fiber reinforced plastic layer.

### CROSS-REFERENCE TO RELATED APPLICATION

This application claims the priority benefit of Japanese Patent Application No. 2019-106345 filed on Jun. 6, 2019, which is fully incorporated herein by reference.

### TECHNICAL FIELD

The present invention relates to a carbon fiber reinforced plastic plate and a method for producing a carbon fiber reinforced plastic plate.

### BACKGROUND OF THE INVENTION

Carbon fiber reinforced plastics (hereinafter sometimes referred to as “CFRP”) are light in weight and have high strength, and are widely used in sport applications such as fishing rods and shafts of golf clubs, industrial applications such as automobiles and airplanes, and construction fields such as building reinforcements.

For example, Patent Document 1 discloses a carbon fiber composite material composed of a nonwoven fabric made of carbon fibers having a fiber length of 5 to 50 mm and a polyarylene sulfide having a weight-average molecular weight of 70,000 to 300,000 as a matrix resin, the carbon fiber composite material having the crack propagation energy Ep obtained by an instrumented Charpy impact test in the range of 0.2 to 2 [J].

Also, Patent Document 2 discloses a method for producing a carbon fiber aggregate in which cut pieces are obtained by cutting an end material of a carbon fiber base material containing carbon fibers, and the cut pieces are made into a nonwoven fabric which is then subjected to carding and/or punching to obtain the carbon fiber aggregate. Patent Document 2 further discloses a method for producing a carbon fiber reinforced plastic in which a carbon fiber aggregate produced by the production method described above is impregnated with a matrix resin.

### PRIOR ART LITERATURE

### Patent Document

Patent Document 1: JP 2016-169276 A

Patent Document 2: JP 5861941 B

### SUMMARY OF THE INVENTION

### Problem to be Solved by the Invention

Although the CFRP obtained by impregnating the nonwoven fabric of the carbon fibers with the base material as in Patent Documents 1 and 2 is excellent in processability, it has inferior strength compared to the CFRP obtained by impregnating, with the base material, the continuous fibers having the same orientation and a long fiber length as the woven fabric of the carbon fibers. On the other hand, in the CFRP obtained by impregnating the woven fabric of the carbon fibers with the base material, when the grinding processing or the like is performed, the fiber fluffs due to the processing, and thus the processability and the smoothness after the processing are inferior compared to the CFRP obtained by impregnating the nonwoven fabric of the carbon fibers with the base material.

It is therefore an object of the present invention to provide a carbon fiber reinforced plastic plate and a method for producing a carbon fiber reinforced plastic plate which can satisfy processability, smoothness after processing and strength.

In order to solve the above-described problems, a carbon fiber reinforced plastic plate of the present invention includes a first carbon fiber reinforced plastic layer including a carbon fiber woven fabric and a base material, and a second carbon fiber reinforced plastic layer including a carbon fiber nonwoven fabric and a base material and having a thickness of 3 mm or less, wherein the second carbon fiber reinforced plastic layer is laminated on the first carbon fiber reinforced plastic layer.

The base material may be a thermosetting resin.

The carbon fiber reinforced plastic plate may include a laminate in which the second carbon fiber reinforced plastic layer, the first carbon fiber reinforced plastic layer and the second carbon fiber reinforced plastic layer are laminated in this sequence.

In the second carbon fiber reinforced plastic layer, a fiber volume content rate of the carbon fiber nonwoven fabric may be 20 to 40 vol %.

In the first carbon fiber reinforced plastic layer, a fiber volume content rate of the carbon fiber woven fabric may be 50 to 60 vol %.

A flatness of the second carbon fiber reinforced plastic layer may be 0.005 to 0.05 mm per 100 mm.

In order to solve the above-mentioned problems, a method for producing a carbon fiber reinforced plastic plate of the present invention is a method for producing the carbon fiber reinforced plastic plate described above and includes a curing step of curing the carbon fiber woven fabric and the carbon fiber nonwoven fabric which are impregnated with the base material.

The method may include a milling step of milling the second carbon fiber reinforced plastic layer after the curing step.

### Advantageous Effect of the Invention

According to the present invention, it is possible to provide a carbon fiber reinforced plastic plate and a method for producing a carbon fiber reinforced plastic plate which can satisfy processability, smoothness after processing and strength.

### BRIEF DESCRIPTION OF THE DRAWINGS

FIG. 1 is a schematic cross-sectional view of a carbon fiber reinforced plastic plate according to one embodiment of the present invention;

FIG. 2 is a schematic cross-sectional view of a carbon fiber reinforced plastic plate according to one embodiment of the present invention different from FIG. 1; and

FIG. 3 is a graph showing evaluation results of bending strength of the CFRP plate in EXAMPLES.

### PREFERRED EMBODIMENTS OF THE INVENTION

In the following, one embodiment of a carbon fiber reinforced plastic plate and a method for producing the carbon fiber reinforced plastic plate according to the present invention will be described with reference to the drawings. The present invention is not limited to the following embodiment.

### [Carbon Fiber Reinforced Plastic Plate]

A carbon fiber reinforced plastic plate of the present invention includes a first carbon fiber reinforced plastic layer and a second carbon fiber reinforced plastic layer. The plate is a hard and rigid plate that does not have flexibility to be bend like CFRP sheets, prepregs or films.

### <First Carbon Fiber Reinforced Plastic Layer>

A first carbon fiber reinforced plastic layer is a layer having a carbon fiber woven fabric and a base material. By employing a woven fabric as the carbon fibers and forming a composite material layer in which the woven fabric is combined with the base material, a strong layer can be provided, thus the CFRP plate of the present invention can ensure the strength as the CFRP plate.

### (Carbon Fiber Woven Fabric)

The carbon fiber woven fabric is a woven fabric in which carbon fibers are used as yarns and the yarns are combined longitudinally and laterally. The carbon fiber has the advantage of being light and strong, and, it is 1/4 times the specific gravity, 10 times the specific strength, and 7 times the specific elastic modulus compared to iron for example. In addition, it is excellent in abrasion resistance, heat resistance, thermal elasticity, acid resistance and electrical conductivity. For example, the carbon fiber can be produced by using acrylic fiber or pitch as a raw material and carbonizing the raw material at a high temperature, and an example of the carbon fiber includes a fiber in which 90% or more by mass is composed of carbon, which is obtained by applying heat carbonization treatment to a precursor of an organic fiber.

With respect to the carbon fibers, the carbon fibers using the acrylic fibers are classified as PAN (Polyacrylonitrile)-based carbon fibers, and the carbon fibers using the pitch are classified as pitch (PITCH)-based carbon fibers. Furthermore, in the case of pitch-based carbon fibers, general-purpose carbon fibers are produced from isotropic pitch-based carbon fibers, and high strength and high elastic modulus carbon fibers are produced from mesophase pitch-based carbon fibers. In the present invention, either one of the PAN-based carbon fibers and the pitch-based carbon fibers can be used. For example, in order to obtain a rigid CFRP, the pitch-based carbon fibers having an excellent rigidity can be used, and in order to obtain a high strength CFRP, the PAN-based carbon fibers having an excellent strength can be used.

As the carbon fiber woven fabric made of such carbon fibers, a bi-directional high strength cloth having a high strength in two directions including a longitudinal direction and a lateral direction can be used. The fiber mass may be 50 to 200 g/m² in length and 50 to 200 g/m² in width, and the thickness may be 0.03 to 0.1 mm in length and 0.03 to 0.1 mm in width.

### (Base Material)

In the CFRP plate, the base material is a material that fills a gap between the carbon fibers, and a synthetic resin or a natural resin can be used for the base material. From the viewpoint of ensuring the strength as the CFRP plate, a thermosetting resin such as an epoxy resin or a urethane resin can be used as the base material. In addition, from the viewpoint of compatibility with the carbon fibers, polybutylene succinate (PBS) or polyphenylene sulfide (PPS) can also be used.

In particular, when the epoxy resin is used as the base material, a copolymer of bisphenol A or bisphenol F and epichlorohydrin can be used as a main material, and an acid anhydride such as various polyamines or phthalic anhydride can be used as a curing agent. In addition, it is preferable to use a solventless resin so that the CFRP plate does not contain a solvent and the plate does not get thinned, and it is preferable to use a resin in liquid form rather than a resin in solid form at a room temperature from the viewpoint of easiness of compositing with the carbon fibers.

As the epoxy resin, specifically, a liquid solventless bisphenol A having an epoxy equivalent weight of 150 to 300 is used as a main material, and a bis-amino compound which is compatible with the bisphenol A and capable of curing upon reaction with the bisphenol A can be used as a curing agent. For example, after the main material and the curing agent are mixed, they can be combined with the carbon fibers before the pot-life ends to form the CFRP plate.

In the first carbon fiber reinforced plastic layer, it is preferable that the fiber volume content rate (Vf) of the carbon fiber woven fabric is 50 to 60 vol %. If Vf is high, there is an advantage that mechanical properties and physical properties are excellent, but the amount of the base material becomes small, and therefore, it may be difficult to form the first carbon fiber reinforced plastic layer. Also, if Vf is high, toughness and surface smoothness may be inferior. On the other hand, if Vf is low, the property of the base material is preferentially developed, and the reinforcing effect by the carbon fibers may be impaired. In view of these points, in the first carbon-fiber-reinforced plastics layer, the strength of the first carbon fiber reinforced plastic layer as the CFRP plate can be sufficiently ensured by setting Vf to 50 to 60 vol %.

### <Second Carbon Fiber Reinforced Plastic Layer>

The second carbon fiber reinforced plastic layer is a layer having a carbon fiber nonwoven fabric and a base material and having a thickness of 3 mm or less. A nonwoven fabric is employed as the carbon fiber and is combined with the base material to form a composite material layer. The carbon fiber nonwoven fabric is inferior in strength compared to the carbon fiber woven fabric when used as the CFRP plate, however fluff is suppressed at the time of processing such as milling, resulting in excellent processability.

### (Carbon Fiber Nonwoven Fabric)

The carbon fiber nonwoven fabric is a sheet-like fabric in which the carbon fibers are not woven but are three-dimensionally entangled using a needle punching method or the like. Details of the carbon fiber are the same as those described above under <first carbon fiber reinforced plastic layer>, and therefore description thereof is omitted here.

As such carbon fiber nonwoven fabric, for example, one based on PAN-based carbon fibers and having a mass of 300 to 1500 g/m² and a thickness of 3 to 15 mm can be used. In addition, a mixed fiber in which rayon fibers, acrylic fibers, thermoplastic resin fibers and other various fibers are combined with the carbon fibers at a predetermined ratio can be used.

In the carbon fiber reinforced plastic plate of the present invention, the second carbon fiber reinforced plastic layer is laminated on the first carbon fiber reinforced plastic layer. By adopting such a lamination mode, it is possible to obtain the CFRP plate which is excellent in processability in milling and such and smoothness with the second carbon fiber reinforced plastic layer laminated on a surface of the first carbon fiber reinforced plastic layer while ensuring the strength as the CFRP plate by the first carbon fiber reinforced plastic layer.

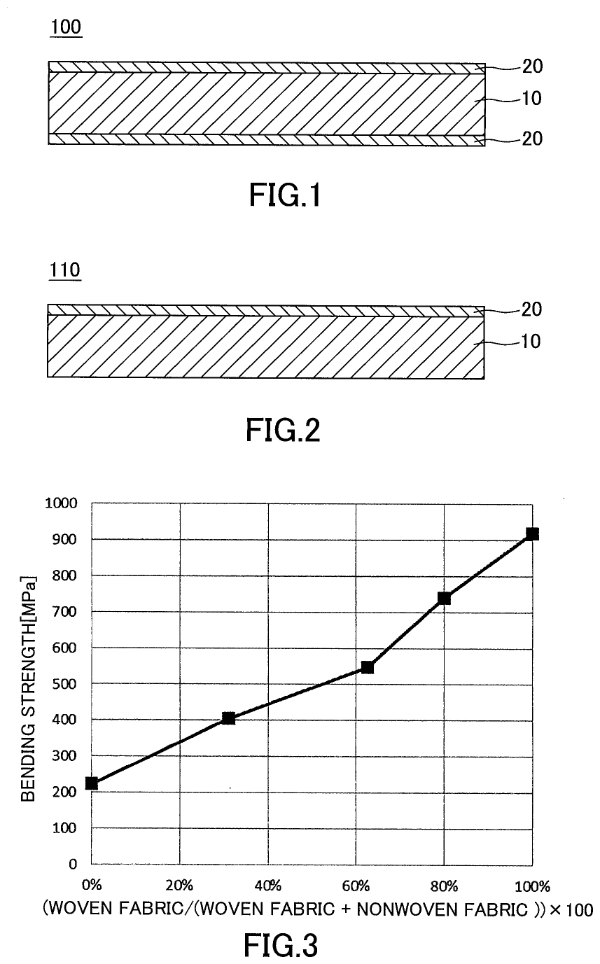

A specific example of the carbon fiber reinforced plastic plate of the present invention will be described with reference to FIGS. 1 and 2. FIG. 1 is a schematic cross-sectional view of a carbon fiber reinforced plastic plate according to one embodiment of the present invention. FIG. 2 is a schematic cross-sectional view of a carbon fiber reinforced plastic plate according to one embodiment of the present invention which is different from FIG. 1.

In a carbon fiber reinforced plastic plate 100 shown in FIG. 1, a second carbon fiber reinforced plastic layer 20 is laminated on a front surface and a back surface of a first carbon fiber reinforced plastic layer 10, that is, the carbon fiber reinforced plastic plate 100 is a laminate in which the second carbon fiber reinforced plastic layer 20, the first carbon fiber reinforced plastic layer 10 and the second carbon fiber reinforced plastic layer 20 are laminated in this sequence. The second carbon fiber reinforced plastic layer 20 is a layer having a thickness of 3 mm or less, and is a layer of about 0.5 to 3 mm in a state before it is subjected to milling, and is a layer of about 0.05 to 0.1 mm in a state after it is subjected to milling in order to smooth a surface of the second carbon fiber reinforced plastic layer 20.

After milling, the smoothness of the surface of the carbon fiber reinforced plastic plate 100, i.e., the surface of the second carbon fiber reinforced plastic layer 20, is higher than that before the milling. For example, the flatness of the second carbon fiber reinforced plastic layer 20 can be adjusted to 0.005 to 0.05 mm per 100 mm.

Further, the carbon fiber reinforced plastic plate may be a laminate in which the second carbon fiber reinforced plastic layer 20 is laminated on either the front surface or the back surface of the first carbon fiber reinforced plastic layer 10 as a carbon fiber reinforced plastic plate 110 shown in FIG. 2. Furthermore, the first carbon fiber reinforced plastic layer 10 may be a single layer made of a carbon fiber woven fabric, or may be a layer with a three-layer structure constituted of a woven fabric, a nonwoven fabric and a woven fabric of the carbon fibers as long as a required strength is satisfied, or may be a multilayer structure with four or more layers.

In the second carbon fiber reinforced plastic layer, it is preferable that the fiber volume content rate (Vf) of the carbon fiber nonwoven fabric is 20 to 40 vol %. If Vf is high, there is an advantage that mechanical properties and physical properties are excellent, but the amount of the base material becomes small, and therefore, it may be difficult to form the second carbon fiber reinforced plastic layer. Also, if Vf is high, toughness, processability and surface smoothness may be inferior. On the other hand, if Vf is low, the property of the base material is preferentially developed, and the reinforcing effect by the carbon fibers may be impaired. In view of these points, in the second carbon fiber reinforced plastic layer, Vf is set to 20 to 40 vol % which is lower than that of the first carbon fiber reinforced plastic layer, so that processability and smoothness of the surface can be satisfied.

As the base material of the second carbon fiber reinforced plastic layer, a thermosetting resin can be used. Details of the thermosetting resin are described above in association with the first carbon fiber reinforced plastic layer, and thus description thereof is omitted.

### (Other Constituent)

The carbon fiber reinforced plastic plate of the present invention may have other element in addition to the first carbon fiber reinforced plastic layer and the second carbon fiber reinforced plastic layer. For example, when the first carbon fiber reinforced plastic layer and the second carbon fiber reinforced plastic layer are adhesively laminated, a resin adhesive layer having good compatibility with the base material can be provided between these layers. In addition, a protective layer or a protective film or the like for protecting the surface of the first carbon fiber reinforced plastic layer or the second carbon fiber reinforced plastic layer until just before the use of the carbon fiber reinforced plastic plate may be provided so as to prevent the surface from being damaged or contaminated.

As the carbon fiber reinforced plastic plate, a thickness of the plate is generally 5 to 100 mm, and in particular, a plate having a thickness of 8 to 40 mm is generally used. The thickness of the first carbon fiber reinforced plastic layer is 80% or more of a total thickness of the carbon fiber reinforced plastic plate, thereby satisfying the strength as the carbon fiber reinforced plastic plate.

### [Method for Producing Carbon Fiber Reinforced Plastic Plate]

Next, a method for producing the above-described carbon fiber reinforced plastic plate of the present invention will be described.

### <Curing Step>

A curing step is a step of curing the carbon fiber woven fabric and the carbon fiber nonwoven fabric which are impregnated with the base material. For example, if the base material is a thermosetting resin, it can be cured by heating. In case of a thermoplastic resin, the carbon fiber woven fabric and the carbon fiber nonwoven fabric can be impregnated with the resin in a heated and melted state, and then they can be cured by cooling to a room temperature.

As a production procedure, the woven fabric and the nonwoven fabric may be laminated and then impregnated with the base material prior to the curing step, and thereafter, the curing step may be performed to produce the CFRP plate, or the woven fabric and the nonwoven fabric may each be impregnated with the base material, and thereafter the curing step may be performed to produce the first carbon fiber reinforced plastic layer and the second carbon fiber reinforced plastic layer separately, and then these layers may be joined together with an adhesive agent or the like to produce the CFRP plate.

When there is a risk that the strength of the CFRP plate is lowered by the presence of the adhesive layer, the woven fabric and the nonwoven fabric can be laminated and then impregnated with the base material by using a VaRTM method for example, followed by performing room temperature curing and heat curing, thereby producing the CFRP plate in which no adhesive layer is present and the second carbon fiber reinforced plastic layer is directly laminated on the first carbon fiber reinforced plastic layer.

### <Milling Step>

The present invention may include a milling step of milling the second carbon fiber reinforced plastic layer after the curing step. In order to improve the surface smoothness of the CFRP plate, the milling can be performed to obtain the flatness of the surface of 0.005 mm to 0.05 mm per 100 mm, for example.

### (Other Step)

The method for producing the carbon fiber reinforced plastic plate of the present invention may include other step in addition to the curing step and the milling step. For example, the present invention may include a step of laminating the woven fabric and the nonwoven fabric of the carbon fibers described above, and an impregnating step of making the laminated carbon fibers impregnated with the base material.

### EXAMPLES

In the following, the present invention will be described in more detail using examples; however, the present invention is not limited to the examples in any way. In the following examples, the CFRP plates were produced, and the produced CFRP plates were evaluated for milling processability or bending strength.

### [Milling Processability and Flatness Evaluation]

### <Production of CFRP Plate>

### Example 1

In a mold (inner dimension: 15×15×1 cm), carbon fiber woven fabrics (BT70-20 manufactured by Toray Industries, Inc.) were laminated in two layers, and further, carbon fiber nonwoven fabrics (CFZ-500SD manufactured by Kanai Juyo Kogyo Co., Ltd.) were laminated in two layers, thereby arranging in the mold the carbon fibers having a four-layered structure. Then, an epoxy resin main material (jER806 manufactured by Mitsubishi Chemical Corporation) and a curing agent (4,4′-methylenebis (2-methylcyclohexylamine) manufactured by Tokyo Chemical Industry Co., Ltd.) were mixed at a mass ratio of 100:36, and then the mixed resin was injected under pressure of 0.5 Mpa by using pressurized injection method into the mold, where the mold was heated to 100° C. and sealed before the mixed resin was injected. After injecting the mixed resin, heat curing was performed at 100° C. for 20 minutes. According to the steps described above, a CFRP plate including the first carbon fiber reinforced plastic layer having the thickness of 0.8 cm (0.4 cm×2) and the Vf of 57 vol %, and the second carbon fiber reinforced plastic layer having the thickness of 0.2 cm (0.1 cm×2) and the Vf of 28 vol % was obtained.

### Comparative Example 1

In a mold (inner dimension: 15×15×1 cm), carbon fiber nonwoven fabrics (CFZ-1000SD manufactured by Kanai Juyo Kogyo Co., Ltd.) were laminated in three layers, and on top thereof one layer of carbon fiber nonwoven fabric (CFZ-250SD manufactured by Kanai Juyo Kogyo Co., Ltd.) was laminated, thereby arranging in the mold a total of four layers of the carbon fiber nonwoven fabrics. Then, an epoxy resin main material (jER806 manufactured by Mitsubishi Chemical Corporation) and a curing agent (4,4′-methylenebis (2-methylcyclohexylamine) manufactured by Tokyo Chemical Industry Co., Ltd.) were mixed at a mass ratio of 100:36, and then the mixed resin was injected under pressure of 0.5 Mpa by using pressurized injection method into the mold, where the mold was heated to 100° C. and sealed before the mixed resin was injected. After injecting the mixed resin, heat curing was performed at 100° C. for 20 minutes. According to the steps described above, a CFRP plate having the thickness of 10 mm and Vf of 21% was obtained.

### Comparative Example 2

In a mold (inner dimension: 15×15×1 cm), carbon fiber nonwoven fabrics (CFZ-1000SD manufactured by Kanai Juyo Kogyo Co., Ltd.) were laminated in five layers, and on top thereof one layer of carbon fiber nonwoven fabric (CFZ-250SD manufactured by Kanai Juyo Kogyo Co., Ltd.) was laminated, thereby arranging in the mold a total of six layers of the carbon fiber nonwoven fabrics. Then, an epoxy resin main material (jER806 manufactured by Mitsubishi Chemical Corporation) and a curing agent (4,4′-methylenebis (2-methylcyclohexylamine) manufactured by Tokyo Chemical Industry Co., Ltd.) were mixed at a mass ratio of 100:36, and then the mixed resin was injected under pressure of 0.5 MPa by using pressurized injection method into the mold, where the mold was heated to 80° C. and sealed before the mixed resin was injected. After injecting the mixed resin, heat curing was performed at 100° C. for 25 minutes. According to the steps described above, a CFRP plate having the thickness of 10 mm and Vf of 31% was obtained.

### Comparative Example 3

In a mold (inner dimension: 15×15×1 cm), carbon fiber nonwoven fabrics (CFZ-1000SD manufactured by Kanai Juyo Kogyo Co., Ltd.) were laminated in seven layers, and on top thereof one layer of carbon fiber nonwoven fabric (CFZ-250SD manufactured by Kanai Juyo kogyo Co., Ltd.) was laminated, thereby arranging in the mold a total of eight layers of the carbon fiber nonwoven fabrics. Then, an epoxy resin main material (jER806 manufactured by Mitsubishi Chemical Corporation) and a curing agent (4,4′-methylenebis (2-methylcyclohexylamine) manufactured by Tokyo Chemical Industry Co., Ltd.) were mixed at a mass ratio of 100:36, and then the mixed resin was injected under pressure of 0.5 MPa by using pressurized injection method into the mold, where the mold was heated to 80° C. and sealed before the mixed resin was injected. After injecting the mixed resin, heat curing was performed at 100° C. for 25 minutes. According to the steps described above, a CFRP plate having a thickness of 10 mm and Vf of 40% was obtained.

### Comparative Example 4

Carbon fibers in which ten layers of carbon fiber woven fabrics (BT70-20 manufactured by Toray Industries, Inc.) having a length of 12 cm and a width of 12 cm were laminated was placed on a metallic plate, and a film and a sealant were used to seal the surrounding of the carbon fibers so that the base material does not leak. Then, an epoxy resin main material (jER806, Mitsubishi Chemical Corporation) and a curing agent (1, 3-BAC manufactured by Mitsubishi Gas Chemical Company, Inc.) were mixed at a mass ratio of 100:21, and then the mixed resin was injected into the carbon fibers by the VaRTM method. After the injection, room temperature curing was performed, and then heat curing was performed under a condition of 150° C. and 60 minutes. According to the steps described above, a CFRP plate having the thickness of 2 mm and Vf of 57 vol % was obtained. No carbon fiber nonwoven fabric was used.

### <Milling Process>

Using the three CFRP plates of Example 1 produced as described above, the milling was performed on the surface of the second carbon fiber reinforced plastic layer under the following “Milling Condition” until the thickness of the second carbon fiber reinforced plastic layer becomes 0.1 mm. Further, the three CFRP plates of Comparative Examples 1 to 4 were used, and the milling under the same condition as that for the CFRP plates of Example 1 was performed.

### (Milling Condition)

Equipment: screw-on type general purpose front milling cutter (manufactured by Mitsubishi Materials Corporation)
Cutter type: ASX44R10005D
Insert: SEGT13T3AGFN-JP HTi10
Rotation speed: S=615 min⁻¹ (V=193 m/min)
Feed speed: F=369 mm/min

For the CFRP plates of Example 1 and Comparative Examples 1 to 4 after the milling, the flatness of the surfaces thereof (the amount of deviation from the geometrically correct plane of a planar body) was measured by using a three-dimensional precision measuring device (ZEISS Ltd., model number: UPMC 850). Average values of the flatness of the three CFRP plates for the respective examples are shown in Table 1.

TABLE 1

| | Flatness per 100 mm after milling | |
|---|---|---|
| | (average value of three CFRP plates) | |
| Example 1 | 0.020 | mm |
| Comparative Example 1 | 0.027 | mm |
| Comparative Example 2 | 0.018 | mm |
| Comparative Example 3 | 0.015 | mm |
| Comparative Example 4 | 0.1 | mm |

The second carbon fiber reinforced plastic layer of the CFRP plate of Example 1 is a layer by using the carbon fiber nonwoven fabric as in Comparative Examples 1 to 3, and the results show that there was no problem in the flatness after the milling and the planarity was high.

On the other hand, in the CFRP plate of Comparative Example 4 using the carbon fiber woven fabric and not using the carbon fiber nonwoven fabric, the fibers were fluffed by the milling, and the flatness had increased by the fluffed fibers and thus the planarity of the plate was low.

### [Evaluation of Bending Strength]

<Production of CFRP plate>

Three kinds of the carbon fiber reinforced plastic plates 110 having different thicknesses of the first carbon fiber reinforced plastic layer (Vf is 57 vol %) and the second carbon fiber reinforced plastic layer (Vf is 28 vol %) were produced by using the same production method as in Example 1, in which the carbon fiber woven fabric and the carbon fiber nonwoven fabric were laminated, the epoxy resin was injected, followed by performing the room temperature curing and the heat curing. Similarly, the CFRP plate using only the carbon fiber woven fabric and the CFRP plate using only the carbon fiber nonwoven fabric were produced. That is, five kinds of the CFRP plates with the same thickness but different ratios of the carbon fiber woven fabric to the carbon fiber nonwoven fabric (indicated as “(woven fabric/(woven fabric+nonwoven fabric))×100” in Table 2 and FIG. 3) were produced.

### <Bending Test>

The five kinds of the CFRP plates were subjected to a bending test under the following condition according to JIS K7074. The measurement results are shown in Table 2 and FIG. 3.
Dimensions of test piece: 100×15 mm, thickness: 2 mm
Test speed: 5 mm/min
Distance between fulcrums L: L=40×h (80 mm)
Radius of indenter R1:R1=5 mm
Radius of support table R2:R2=2 mm
Flexural modulus: tangential method

TABLE 2

| | (woven fabric/(woven fabric + | | | | |
|---|---|---|---|---|---|
| | nonwoven fabric)) × 100 | | | | |
| | 0% | 31% | 63% | 80% | 100% |
| bending strength (MPa) | 223 | 404 | 547 | 740 | 920 |

As a practical CFRP plate, it is important to ensure the bending strength of 80% or more of the bending strength of the CFRP plate that uses only the carbon fiber woven fabric as the carbon fiber even when the carbon fiber nonwoven fabric is added. From Table 2 and FIG. 3, it was found that when the carbon fiber woven fabric and the carbon fiber nonwoven fabric were used in combination, a sufficient strength can be ensured when the CFRP plate has the percentage of the carbon fiber woven fabric is 80% or more, that is, when the thickness of the first carbon fiber reinforced plastic layer is 80% or more of the thickness of the CFRP plate.

### <Summary>

As described above, the carbon fiber reinforced plastic plate of the present invention can satisfy processability, smoothness after processing and strength. Therefore, it can be used for die set parts of a press die, for example, and it is half or less in weight of a conventional metallic plate, and thus by using it in die parts and such which are driven at high speed, the positioning accuracy can be improved.

### LIST OF REFERENCE SIGNS

10 first carbon fiber reinforced plastic layer

20 second carbon fiber reinforced plastic layer

100 carbon fiber reinforced plastic plate

110 carbon fiber reinforced plastic plate

1. A carbon fiber reinforced plastic plate comprising:
a first carbon fiber reinforced plastic layer including a carbon fiber woven fabric and a base material; and
a second carbon fiber reinforced plastic layer including a carbon fiber nonwoven fabric and a base material, and having a thickness of 3 mm or less,
wherein the second carbon fiber reinforced plastic layer is laminated on the first carbon fiber reinforced plastic layer.

2. The carbon fiber reinforced plastic plate according to claim 1, wherein the base material is a thermosetting resin.

3. The carbon fiber reinforced plastic plate according to claim 1, comprising a laminate in which the second carbon fiber reinforced plastic layer, the first carbon fiber reinforced plastic layer and the second carbon fiber reinforced plastic layer are laminated in this sequence.

4. The carbon fiber reinforced plastic plate according to claim 1, wherein in the second carbon fiber reinforced plastic layer, a fiber volume content rate of the carbon fiber nonwoven fabric is 20 to 40 vol %.

5. The carbon fiber reinforced plastic plate according to claim 1, wherein in the first carbon fiber reinforced plastic layer, a fiber volume content rate of the carbon fiber woven fabric is 50 to 60 vol %.

6. The carbon fiber reinforced plastic plate according to claim 1, wherein a flatness of the second carbon fiber reinforced plastic layer is 0.005 to 0.05 mm per 100 mm.

7. A method for producing the carbon fiber reinforced plastic plate according to claim 1, comprising
a curing step of curing a carbon fiber woven fabric and a carbon fiber nonwoven fabric which are impregnated with a base material.

8. The method according to claim 7, comprising a milling step of milling the second carbon fiber reinforced plastic layer after the curing step.
